(19) United States
(12) Patent Application Publication
(10) Pub. No.: US 2019/0378024 A1
(43) Pub. Date: Dec. 12, 2019

(54) SYSTEMS TO AUGMENT CONVERSATIONS WITH RELEVANT INFORMATION OR AUTOMATION USING PROACTIVE BOTS

(71) Applicant: Second Mind Labs, Inc., New York, NY (US)

(72) Inventors: Kul Singh, New York, NY (US); Andras Kornai, Cambridge, MA (US); Yurii Pohrebniak, Kyiv (UA)

(73) Assignee: Second Mind Labs, Inc., New York, NY (US)

(21) Appl. No.: 16/469,585

(22) PCT Filed: Dec. 15, 2017
(86) PCT No.: PCT/US2017/066880

§ 371 Date: Jun. 13, 2019

Related U.S. Application Data
(60) Provisional application No. 62/536,890, filed on Jul. 25, 2017.
(60) Provisional application No. 62/438,367, filed on Dec. 22, 2016.
(60) Provisional application No. 62/435,635, filed on Dec. 16, 2016.

(51) Int. Cl. G06N 5/04; G06N 20/00; G06F 16/9032; G06F 16/9038; H04L 12/58

(52) U.S. Cl. CPC G06N 5/043; G06N 20/00; H04L 51/02; G06F 16/9038; G06F 16/90332

(57) ABSTRACT

Aspects of the technology described herein relate generally to a platform that enables the deployment of autonomous bots that identify and deliver relevant content in real-time based on received information. These bots may be designed to proactively provide relevant content without any explicit trigger from a user. For example, a bot may analyze speech and/or text in a primary communication channel (e.g., a telephone, email, webchat, or videophone) and proactively provide content relevant to the speech and/or text in one or more secondary communication channels (e.g., displayed on a computer screen, a mobile device screen, and/or a pair of smart glasses).

### CROSS-REFERENCE TO RELATED APPLICATIONS

This application claims the benefit under 35 U.S.C. § 119(e) of each of U.S. Provisional Application Ser. No. 62/435,635, titled “EVENT-BASED ARCHITECTURE ENABLING A PROACTIVE BOT TO DELIVER RELEVANT RESULTS IN REAL-TIME” filed on Dec. 16, 2016, U.S. Provisional Application Ser. No. 62/438,367, titled “MULTI-CHANNEL COMMUNICATIONS THAT ENRICH DISCUSSION ON A PRIMARY CHANNEL BY PROVIDING INFORMATION IN A SECONDARY CHANNEL” filed on Dec. 22, 2016, U.S. Provisional Application Ser. No. 62/536,890, titled “MULTI-CHANNEL COMMUNICATIONS THAT ENRICH DISCUSSION ON A PRIMARY CHANNEL BY PROVIDING INFORMATION IN A SECONDARY CHANNEL” filed on Jul. 25, 2017, each of which is hereby incorporated herein by reference in its entirety.

### FIELD

Aspects of the technology described herein relate generally to a platform that enables the deployment of autonomous bots that identify and deliver relevant content in real-time based on received information. In some embodiments, the platform may be employed to enable multi-channel communication where one or more autonomous bots analyze speech and/or text in a primary communication channel (e.g., a telephone, email, webchat, or videophone) and provide content relevant to the speech and/or text in one or more secondary communication channels.

### BACKGROUND

Heterogeneous communication networks, where some of the nodes in the network are humans and some are non-humans (e.g., an automated bank telling machine, a virtual assistant on an electronic device), are becoming increasingly common. Such heterogeneous communication systems are characterized by humans taking the initiative to start the communication with the non-human systems operating passively. For example, a virtual assistant on an electronic device typically requires a “wake-up” word to trigger the virtual assistant to start. Examples of such a virtual assistant include SIRI by APPLE, GOOGLE ASSISTANT by GOOGLE, CORTANA by MICROSOFT, and ALEXA by AMAZON.

### SUMMARY

According to one aspect, a system is provided comprising at least one virtualized or hardware processor, at least one non-transitory computer-readable storage medium storing processor-executable instructions organized as a first bot computer program that, when executed by the at least one virtualized or hardware processor, cause the at least one virtualized or hardware processor to perform acts of receiving information, searching of at least one first data source using a first technique to find information to augment the received information, determining an evaluation of the at least one first data source responsive to the received information, determining a result from the search of the at least one first data source from the at least one first data source responsive to the evaluation of the at least one first data source, and providing at least one first message comprising the determined result to at least one subscriber.

According to one embodiment, the received information includes at least one of: a news article, speech by a subject, a discussion between two or more subjects, a video stream, an audio stream, a streaming dataflow, and a scientific study. According to another embodiment, the system further comprises receiving feedback from the at least one subscriber regarding the at least one first message and updating at least one characteristic of the first technique based on the received feedback from the at least one subscriber regarding the at least one first message.

In another embodiment, the processor-executable instructions are organized as a plurality of bot computer programs, and wherein the plurality of bot computer programs each are adapted to process a same input of received information. In another embodiment, the same input of received information is at least one of a received audio stream. In another embodiment, the at least one first bot computer program includes a plurality of adjustable parameter comprising at least one of a resource parameter that defines a computer resource limit that can be used by the at least one first bot computer program.

In another embodiment, the at least one first bot computer program includes a plurality of adjustable parameter comprising at least one of an error rejection parameter that defines a rate of error rejection used by the at least one first bot computer program. In another embodiment, the processor-executable instructions are organized as the first bot computer program further cause the at least one virtualized or hardware processor to perform providing the at least one first message to the at least one subscriber responsive to generating the at least one first message within a predetermined period of time from receiving the information. In another embodiment, the predetermined period of time is no more than 2 seconds. In another embodiment, is no more than 4 seconds. In another embodiment, the first technique includes at least one artificial intelligence technique. In another embodiment, the at least one subscriber is non-human. In another embodiment, the at least one subscriber is a bot program.

In another embodiment, the at least one non-transitory computer-readable storage medium further stores processor-executable instructions organized as a second bot computer program that, when executed by the at least one virtualized or hardware processor, cause the at least one virtualized or hardware processor to perform receiving the information, searching at least one second data source using a second technique to find information to augment the received information, and providing at least one second message to at least one subscriber based on a result from the search of the at least one second data source. In another embodiment, the processor-executable instructions organized as the second bot computer program further cause the at least one virtualized or hardware processor to perform receiving feedback from the at least one subscriber regarding the at least one second message, and updating at least one characteristic of the second technique based on the received feedback from the at least one subscriber regarding the at least one second message.

According to at least one aspect, a system is provided. The system includes at least one virtualized or hardware processor and at least one non-transitory computer-readable storage medium storing processor-executable instructions organized as a first bot computer program that, when executed by the at least one virtualized or hardware processor, cause the at least one virtualized or hardware processor to perform acts of: receiving a voice signal indicative of speech, identifying at least one first data source from a plurality of data sources, searching the identified at least one first data source using a first technique to find information to augment at least a portion of the speech, determining a result from the search of the at least one first data source, and providing at least one first message including the determined result to at least one subscriber.

In some embodiments, the processor-executable instructions organized as the first bot computer program further cause the at least one virtualized or hardware processor to perform acts of: receiving feedback from the at least one subscriber regarding the at least one first message and updating at least one characteristic of the first technique based on the received feedback from the at least one subscriber regarding the at least one first message.

In some embodiments, the at least one non-transitory computer-readable storage medium further stores processor-executable instructions organized as a second bot computer program that, when executed by the at least one virtualized or hardware processor, cause the at least one virtualized or hardware processor to perform acts of: receiving the voice signal indicative of speech, searching at least one second data source from the plurality of data sources using a second technique to find information to augment at least a portion of the speech, and providing at least one second message to at least one subscriber based on a result from the search of the at least one second data source.

In some embodiments, the processor-executable instructions organized as the second bot computer program further cause the at least one virtualized or hardware processor to perform acts of: receiving feedback from the at least one subscriber regarding the at least one second message and updating at least one characteristic of the second technique based on the received feedback from the at least one subscriber regarding the at least one second message.

In some embodiments, the first technique includes at least one artificial intelligence technique. In some embodiments, the at least one subscriber is non-human. In some embodiments, the at least one subscriber is a second bot computer program. In some embodiments, the system further includes a display and wherein providing the at least one message to the at least one subscriber includes displaying the at least one message on the display.

In some embodiments, the processor-executable instructions organized as the first bot computer program further cause the at least one virtualized or hardware processor to perform an act of: providing the at least one first message to the at least one subscriber responsive to generating the at least one first message within a predetermined period of time from receiving the voice signal. In some embodiments, the predetermined period of time is no more than 2 seconds. In some embodiments, the predetermined period of time is no more than 4 seconds.

In some embodiments, at least one device that receives a voice signal indicative of speech includes at least one of a group of devices comprising augmented reality glasses, mixed reality glasses, virtual reality glasses, or a smartphone paired to any of the group of devices. In some embodiments, the at least one of a group of devices or the smartphone paired to any of the group of devices is adapted to project or output information to a screen. In some embodiments, the system further comprises a specialized version of augmented or mixed reality glasses not having computer vision capabilities.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “ this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 shows a block diagram of an example system architecture for one or more bot computer programs, according to some embodiments;

FIG. 2 shows an example process, according to some embodiments;

FIG. 3A shows a block diagram of an example system configured to provide a secondary communication channel to a subscriber, according to some embodiments;

FIG. 3B shows a block diagram of an example system configured to provide a secondary communication channel to a subscriber with a caching engine, according to some embodiments;

FIG. 4 shows an example process to augment a conversation with information on a secondary channel, according to some embodiments;

FIG. 5 shows another example process to augment a conversation with information on a second channel, according to some embodiments;

FIG. 6 shows a block diagram of an example implementation of aspects of the system shown in FIG. 3A using web-sockets, according to some embodiments; and

FIG. 7 shows a block diagram of an example special-purpose computer system, according to some embodiments.

### DETAILED DESCRIPTION

As discussed above, conventional devices in heterogeneous communication systems typically await a human user to interact with the electronic device prior to performing an action. For example, a virtual assistant may await a “wake-up” word before starting an operation, a computer system may await input from a keyboard and/or mouse before starting an operation, and an automated teller machine way await depression of one or more keys before starting an operation. Thereby, a user must take the time to initiate communication with the device before the device provides any useful information to the user.

The inventors have appreciated that individuals spend a considerable amount of time interacting with electronic devices to find useful information. For example, knowledge workers who perform non-routine problem solving (e.g., computer programmers, physicians, pharmacists, architects, engineers, etc.) may spend up to 30% of their workday searching for information. The considerable amount of time wasted searching for useful information may, for example, cost companies up to $14,500 per employee per year in lost productivity.

Accordingly, aspects of the present disclosure relate to system architectures that facilitate the deployment of bot computer programs (termed “bots”) that are configured to autonomously monitor input data (e.g., the speech from a voice conversation between two individuals) and provide information that is relevant to the input data (e.g., relevant to the conversation) to one or more subscribers to these bots (e.g., human users and/or non-human users). In some embodiments, the bots may be proactive bots. Proactive bots, unlike traditional passive bots, do not require a specific instruction to begin functioning (e.g., a wake-up word for a virtual assistant). Thereby, the bots may operate autonomously and provide valuable information to subscribers without the subscriber spending any time searching for the information. For example, a bot may receive as input part of a conversation saying “what is the price of bitcoin today?” and the bot may automatically (without any action from the subscribers) retrieve the current price of bitcoin and provide the current price of bitcoin to the subscribers. As a result, the subscriber gets relevant information quickly without interrupting the conversation or having to: (1) start a web-browser application; (2) navigate to a cryptocurrency exchange web-page; and (3) find the price of bitcoin on the web-page.

In some embodiments, the proactive bots described herein may (1) make a judgement call on whether to trigger, use particular data sources, and/or provide an output message if justified and (2) learn from whether the subscriber found its previous output messages attempts useful. Such a proactive bot is different from a traditional sensor monitoring systems (e.g., a fuel alarm system in an airplane) because such systems do not exercise any judgement. For example, a fuel alarm system may measure the fuel level and always issue an alarm if the fuel level is below a predetermined level. Such a fuel alarm system does not exercise any discretion as to, for example, whether to issue the alarm, when to issue the alarm, or how to issue the alarm.

In some embodiments, the proactive bots themselves and/or the system architecture in which the bots operate may allow for adaption over time. The adaption may be performed using feedback from subscribers. For example, a proactive bot may send a message to a subscriber regarding a definition of a term used in a conversation with another person and the subscriber may ignore the definition because the subscriber is an expert in the field. In this example, the proactive bot may adapt to stop providing definitions of terms and start providing scholarly articles regarding words and/or phrases used in conversation. This adaptation allows the proactive bots to adjust their own behavior in deciding whether to provide a message to the subscriber. Any of a variety of techniques may be employed to perform the adaption based on feedback from the subscriber. For example, classical learning theories such as Hebbian (Hebb 1949), anti-Hebbian (Bell 1981), adaptive boosting (AdaBoost), neocognitron (Fukushima 1980), and machine learning (e.g., deep learning) algorithms can be employed. In this regard, the architecture is universal and not tied to any specific learning algorithm, although certain learning algorithms may be beneficial in certain applications.

The inventors have appreciated that the information provided by a proactive bot to a subscriber may be more useful if the information is provided in real-time (or close to real-time). For example, additional information regarding a company that is being discussed is more useful while the company is still being discussed as opposed to five minutes after the conversation has ended. Accordingly, in some embodiments, the proactive bots may be constructed to (1) guarantee low latency (e.g., on the order of 1 or 2 seconds) from the point in time that a signal is detected from a voice input or other front channel input and (2) adapt based on feedback from the subscriber in real-time (e.g., on the order of milliseconds). Also, according to some embodiments, the proactive bots may be capable of learning over time, such as detecting anomalies within the front channel input, learning the information requirements of a particular user, and/or learning a new data source (e.g., an external data source) for use in future detections. This learning may be performed responsive to user feedback, feedback of other users or the environment at large, and/or responsive to other data inputs and/or processes. Further, the bots may be capable of communicating with each other and/or other entities via a second channel in real or near-real time. Information learned by bots may be stored (e.g., in a distributed database, table or other storage construct and/or system) and may be shared with other bots and/or systems.

According to at least one aspect, bots may have one or more inputs and outputs. In some embodiments, one or more bots may have a common channel input, such as a voice signal. The voice signal may originate from a particular user or a group of users. Certain bots may be privy to a certain voice signal or specified groups of voice signals. Bots may also be assigned to certain users, data sources, or combinations thereof. Bots that share a common channel input and that are adapted to provide a channel output (e.g., to a user), may communicate using one or more coordination protocols. In one example, the system may include one or more mechanisms (e.g., ranking, scoring, fairness algorithms, etc.) to determine which bot provides an output on the common channel. Certain bots may have specializations that includes bot-bot coordination. Coordination communication between bots may occur in the millisecond or faster range on a secondary or otherwise separate communication channel. Bots may also operate responsive to an incentive system (e.g., bitcoin or any other cryptocurrency) that provides incentives to bots that provide the necessary data. For instance, a bot that provides a qualified output to another bot may be provided an incentive. In another implementation, a bot that provides an output that is used by another bot (or user) may be awarded an incentive. In this way, a marketplace for information may be provided that operates within a bot network.

According to another aspect, bots may identify (and/or store) natural language triggers (NLTs). In one implementation, NLTs are portions of natural language from one or more conversations, voice inputs, or other voice information. Such NLTs may be associated with particular data sources (e.g., by bots). In one implementation, bots identify NLTs, associate them with one or more data sources, and store the mapping in a memory (e.g., in a table or other data structure) where they can be quickly retrieved. Bots may harvest NLTs for one or more data sources over time, store these associations, and can look up and retrieve the data sources in real time. Additionally (or alternatively), bots may harvest NLTs from a set of readily available files associated with a user such as their emails, documents, and/or chats. Responsive to a real-time identification of an NLT, one or more data sources may be provided within a prescribed latency period (e.g., 0.25 seconds, 0.5 seconds, 1 second, 2 seconds, 3 seconds, etc.). Some aspects may be performed in hardware (e.g., by application-specific integrated circuit(s)) or fast memory systems, further lowering latency between identification of an NLT and providing a response. In this manner, bot performance may be improved as the overall system learns and adapts to new data sources, new NLTs, and system knowledge.

In one embodiment, a bot may identify an NLT and determine, for a particular identified NLT, a strength of a match of a data source to the NLT. If the bot cannot ensure the particular NLT has a particular strength, a message from that bot identifying the NTL and data source may be suppressed. According to one embodiment, bots are both proactive and self-censoring in their behavior regarding data sources. As a result of identifying an NLT, a bot may return a message (e.g., in an interface to a user) if this can be accomplished within a particular latency period (e.g., 1-2 seconds or other predetermined period necessary for providing useful real-time information while the input is being received and processed).

According to various embodiments, certain aspects of the bots may be adjustable (e.g., by a system administrator, user, etc.). Such adjustment may be performed, for example, through a programmatic interface, a graphical interface, or any other type of interface. For example, a bot may have one or more performance parameters that govern how responsive and how many resources a particular bot will take. For instance, the amount of CPU time, CPU priority, and/or memory usage may be adjusted. In another implementation, an adjustable parameter may be provided that allows the system, user, etc., to change an error reject tradeoff parameter that controls the amount of tolerable recognition error. If the acceptable error rate is set to a low value, more signals will be reported incorrectly. In one implementation, such a parameter may be adjustable to control how much signal will result in the return of data.

In some embodiments, the system architecture described herein comprises nodes and edges representing interconnects between these nodes. Nodes may be, for example, computer systems executing one or more bots. Viewed from the outside, a node may be characterized by a single address (such as an IP address) that serves as its unique identifier and a behavioral characterization that describes its reaction to timed input sequences delivered to this address both in terms of state change (if any) and in terms of output signals, possibly including the destination and/or routing information associated to such outputs and their precise timing. In some embodiments, humans may be viewed as special nodes both because their internal decision mechanisms are not fully understood and because they directly interface with several other nodes (e.g. their cellphone, tablet, different windows on their workstation, etc.) and with other humans within range.

Messages may be passed over edges between various nodes using, for example, a standard TCP/IP transport layer (with or without encryption). For example, a first node may subscribe to a second node and the first node may receive messages from the second node over an edge. Edges in the system may be characterized by their medium (e.g. acoustic, optical, digital) and by the range of messages they carry (e.g. sound waves or ether packets). The classification may be fluid because messages can be encoded in many ways including, for example, as continuous (analog) messages or discrete (digital) messages. Generally, the nodes may use the highest functional level of the message. For example, the node may be indifferent as to the particular character encoding that was used to transmit text data or the codec used to transmit voice data.

For important classes of meta-information, such as source and recipient addresses, sending and delivery dates, the system architecture may rely on standardized formats and specifications for how such meta-information can be gleaned from the high-level message and its envelope. While any implementation may rely on such standardized methods (e.g. the series of RFCs from 822 to 5322 and beyond that describe how to parse email), the system architecture does not specifically rely on any particular standard.

One particularly important class of meta-information concerns the behavior of the humans at special nodes. The system architecture may assume that interactions of the humans with their communications devices are logged, that such logs can be preprocessed at these nodes (possibly including encryption and anonymization to address privacy concerns), and that the condensed/compressed logs may form background messages that can be sent or broadcast to other nodes. For example, the logs may contain information whether a particular email was opened, whether a URL in an instant message was clicked on, etc. The architecture supports, but does not require, direct monitoring of human activity such as key logging (e.g., tracking the keys depressed by a user) or eyegaze tracking (e.g., tracking eye movement of a user). Meta-information may also be collected from non-human entities such as other bots, systems, or other types of entities.

Foreground messages carry the contents normally exchanged among nodes, such as sensor readings, stock quotes, voice conversation, and text messages. In some embodiments, such communication (e.g., a voice conversation) may be monitored by a broad variety of proactive bots, and the architecture may enable these bots to learn, in a distributed fashion, how important they are for a given human node.

As should be appreciated from the foregoing, the techniques described herein to autonomously provide relevant information to subscribers improves upon existing computer technology. For example, the bots described herein are capable of proactively providing relevant information without explicitly being triggered, unlike conventional devices. Further, the bots enable the computer system to provide relevant information to a user faster than conventional devices because no input (e.g., from a human) is required before the bot finds and delivers the relevant information. Accordingly, the techniques described herein to autonomously provide relevant information to subscribers represent an improvement to existing computer technology.

It should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

### Example System Architecture and Associated Methods

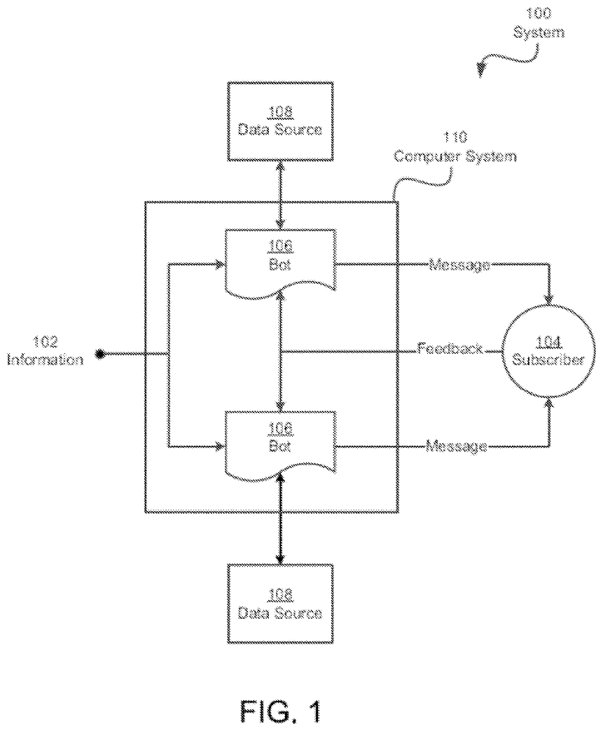

An example system architecture is shown in FIG. 1 by system 100. As shown, the system 100 includes a computer system 110 (e.g., a node) that receives information 102 and provides messages to a subscriber 104 (e.g., a special node that is a human, another bot, system, or other entity type) over an edge. In one particular embodiment, the subscriber is the provider of the information used to detect events (e.g., the subscriber provides a voice input and receives output data responsive to that input). In one embodiment, the information that is used to detect events is considered internal to the system (e.g., it is associated with a primary channel (e.g., an audio or video input) and is the main information acted on by the system being used by the subscriber). Bots may use information from sources stored internally to the system to respond and provide messages to a subscriber responsive to detected events, but according to one embodiment, the bots may use and evaluate one or more outside sources of information.

The computer system 110 includes multiple bots 106 that receive the information 102 and search data sources 108 to identify information relevant to the received information 102. The bots are adapted to make a judgement call on whether providing an output message is justified and/or learn from whether the subscriber found its previous output messages attempts useful. The bots may make this judgement call internally, and may provide one or more outputs to the subscriber based on one or more judgement calls. The bots 106 may each provide outputs in the form of messages sent to the subscriber based on the results of the search of the data sources 108. For instance, a bot may cause a message to be displayed within an interface presented to the subscriber, or may send a message to another bot associated with a subscriber, or may perform some other action. In turn, the bots 106 may receive feedback from the subscriber 104 indicative of a usefulness of the messages and adapt over time to provide more useful information to the subscriber 104. Bots may adaptively modify adjust their response to input events, their information sources, and the type and content of information they may provide to a subscriber.

It should be appreciated that the example system architecture shown in FIG. 1 is only for illustration. Various changes may be made to the system architecture without departing from the scope of the present disclosure. For example, (1) the computer system 110 may execute more, or fewer, bots 106, (2) the bots 106 may share a common data source 108 and/or use non-overlapping data sources 108, and/or (3) hardware acceleration (e.g., by GPUs, FPGAs, and cloud implementations of GPUs or FPGAs) may be used to minimize latency of the system 100 between receipt of information 102 and issuance of a message to the subscriber 104.

In some embodiments, the system 100 is event-driven. Example events include receipt of feedback from the subscriber 104 and/or receipt of information 102. For example, the system 100 may receive information 102 and the bots 106 within the system architecture may automatically process the received information upon receipt of the information 102 to generate messages for the subscriber 104.

In some embodiments, the computer system 110 may interact with physical or information systems (we note that with the emergence of cyber-physical systems these two need no longer be strictly separated) that are outside the system architecture described herein. For example, a first bot of the bots 106 may monitor an audio stream (e.g., a telephone conversation) and selectively provide alarms about content identified within the conversation while a second bot of the bots 106 may monitor a different conversation or audio source within the same conversation. Audio information within the information may trigger events that cause the bot to perform actions. The central function of the system architecture may include the ability to enable distributed machine-learning of the right degree of proactivity for such bots 106.

In some embodiments, the messages from the bots 106 may be selectively delivered to the subscriber 104. For example, the messages from the bots 106 may be selectively provided to subscriber 104 when the subscriber 104 does not provide feedback messages (e.g., for reasons of privacy). It is understood that the specificity of such messages to the subscriber 104 (e.g. suggestions of a portion of external content retrieved from a data source responsive to a monitored conversation trigger (e.g., NLT)) may be different when the system 100 has access to the behavior of the subscriber 104 and can adapt over-time.

In some embodiments, the range or information inferred by the bots 106 from the received information 102 is not limited. Examples include a keyword, or entity mentions in natural language, a probabilistic photo description provided by visual recognition technology, a sentiment score, or other type of information.

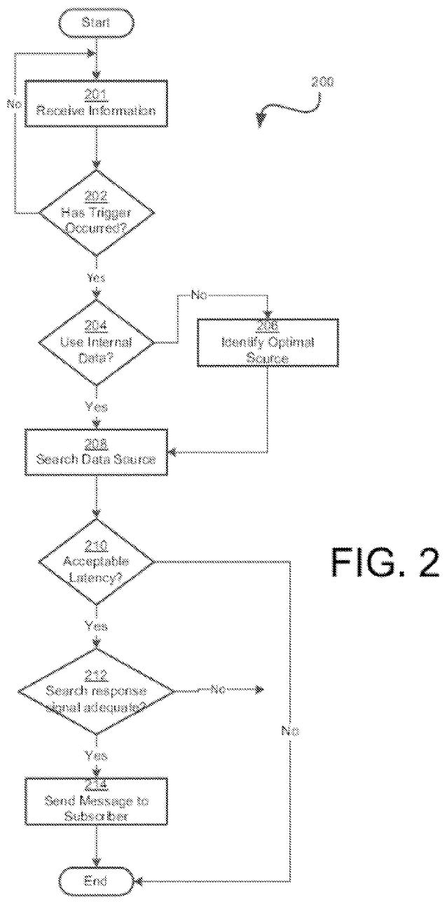

As discussed above, the system 100 may be configured receive the information 102 and provides messages to the subscriber 104 based on the received information 102. FIG. 2 shows an example process 200 for generating such messages for the subscriber 104. As shown, the process 200 comprises an act 201 of receiving information, an act 202 of determining whether a trigger has occurred, an act 204 of determining whether to use internal data, an act 206 of identifying an optical source, an act 208 of searching the data source, an act 210 of determining whether the latency is acceptable, an act 212 of determining whether the search response signal is adequate, and an act 214 of sending a message to the subscriber.

In act 201, the system receives information. The information may be, for example, a news article or speech from a conversation being observed and/or participated in by the subscriber 104.

In act 202, it is determined whether a trigger event has occurred for the received information. For instance, the system may monitor a particular audio stream and determine whether an event occurs within the natural language. Such information may define a natural language trigger (NLT) as discussed above. The bot may be adjustable to recognize certain sets of NLTs and/or learn relevant NLTs over time.

In act 204, the system may determine whether data internal to the system architecture may be used to accurately augment the information received in act 202. For example, the system may determine it can deliver the necessary data or “an accurate answer” (on a probabilistic basis) using internal data better than using third party sources because it is faster than checking other sources (lower latency), more accurate than other sources, and/or in some cases may be the only system that can provide the data the subscriber is seeking. In some embodiments, the system may have direct access to some database, a computational program, or an analytics program which enables it to provide the data or to calculate an answer. In addition, the system may utilize machine learning, reasoning, neuroscience, and cognitive artificial intelligence techniques that learn answers over time, and stores this information such that it can provide internal data or answer more quickly versus spending time looking on a third party data source.

If the system determines that the best data must be obtained from a third party data source in act 204, the system proceeds to act 206 and determines the optimal data source. The system may apply semantic context on the content to see if it can be determined which is the optimal data source. For example, reference to the term “file” may indicate the best match would be best found in a document repository (e.g., DROPBOX). In addition, the system may continuously self-learn to determine which is the optimal data source by using machine learning techniques (where initial embodiment of the invention shall use neural networks, but new techniques may be considered including memory networks, cognitive science/reasoning techniques) in order to reduce the latency to deliver the “best data” associated to an NLT for each subscriber.

It should be appreciated that other approaches may be employed additionally or in-place of semantic context. Other example approaches include, but not limited to, storing NLTs and associated “best data sources” in: (i) a connected (either inline or otherwise) caching engine in real-time (as used in high frequency trading systems); (ii) in a dynamic topics/source table (similar to a routing table in a publish/ subscribe system) which the system continuously updates in real-time where when an NLT) is generated, the routing engine checks to see if it matches a previously stored NLT and data source; or (iii) within memory networks. The system may also use anomaly detection to expedite learning to identify outliers for NLTs and determining if there is new information to be learned, and how to utilize that information with regards to NLTs and data sources.

If there is a single previous mapping of an NLT to a data source using these techniques described above, the system may immediately access this data source, match the data by NLT, and deliver data to the subscriber. If there are multiple mappings or matches to an NLT across sources, an algorithm may be applied to define what data is shown to the subscriber to, for example, eliminate overwhelming the subscriber with too much data. The algorithm may be a function of time (e.g., reducing latency to milliseconds), best data source, and context of the content. This use of context may employ machine learning and cognitive techniques, and information regarding context may be stored and retrieved by the system. After a certain amount of time/latency, if data is found from one source and no other data is found, data from the only available source may be delivered to the subscriber. In other words, given the real-time nature requirements of the system there needs to be some cut-off as to how long the system can seek data from other data sources. In certain cases even the best available data won't be shown to a specific subscriber depending on any new trigger events that may arise from the initial trigger event for a specific subscriber. Alternatively (or additionally) the system may make a determination on its own if there is signal and if the system can deliver relevant data in a timely manner that is useful to the subscriber. If not, the system may discard the data for a specific signal/NLT and seek to deliver on the next event trigger. In this manner, the system may function like a daemon in a market data architecture where it passes on some data to the subscriber and discards other data based on some pre-defined rules. Those rules may be based on latency, data relevancy, and learning of the system itself based on machine techniques. In some implementations, the user or other interface (e.g., an adjustable slider, menu item, or other control input) may be provided that allows an external entity to control the parameters of the system (e.g., a bot), such as acceptable latency, error rates in reporting, triggering, weighting of certain data sources or other operational parameters. It should be also noted that in certain implementations, data from multiple sources may be shown either as a function of configuration by subscriber or as determined by the system itself. The algorithm that determines this will be constantly self-tuned and self-learning to optimize results.

If there is no clear existing mapping of an NLT, the system may actively seek matches using application program interfaces (APIs) of data sources. In certain embodiments, the system may use existing Natural Language Processing (NLP) products that already analyze and classify data from a source or even a market sector (examples of these NLP products include, for example, FINDO). These may serve as new NLP liquidity pools that parallel market data liquidity pools similar to ones created by ARCHIPELAGO for market data. The system may connect and integrate with these NLP liquidity pools systems in terms of integrations and also in terms of having knowledge which is the best source for a specific NLT. The system may leverage context-based NLT-to-NLT connectors for data requests to NLP liquidity to optimize for low latency and functionality. For example, this will allow for complex and contextual natural language queries as opposed to just keyword searches. The system may utilize machine learning techniques to learn and remember what contextual NLT queries produced the best results from each source.

In cases where there are no NLP products, integrations, or liquidity pools, the system may seek to provide its own real-time integrations for data sources and market sectors. In addition, the system may provide a Developer's API and platform for third parties to integrate their own applications as data sources into the architecture, which would allow their data to be accessible by our middleware and therefore any relevant subscribing node (user or application). This may provide a mechanism for the system to have access to and index data from other applications.

Once the best data source has been identified, the system may proceed to act 208 to search the identified data source to obtain information that is related to and/or augments the information received in act 202.

In act 210, the system may determine whether the resulting latency between the time the information was received in act 202 and the time the message would be sent to subscriber (if it were to be sent) is acceptable. For example, the system may identify how much time has passed since the information was received in act 202 and determine whether the identified amount of time exceeds a threshold (e.g., 2, 3, 4, 5 seconds or any other threshold amount within a defined tolerance for the application and/or usability of the system in real time). In one embodiment, information should be capable of being delivered with minimal delay from triggers detected within a running conversation or other type of input. According to one embodiment, the information should be capable of being delivered within a threshold period from determination of the NLT. If the latency is acceptable, the system proceeds to act 212 to determine whether the search result has a signal that is worthy of being reported to the user. For instance, in one embodiment, the determination of whether a response is worthy to be returned to a user may be based on a number of factors. For instance, a ranking score may be used to evaluate multiple responses (e.g., received from one or more data sources), and return a few or even one highest ranked response to the subscriber. For instance, the ranking may depend, at least in part, on a ranking of the source of the information (e.g., a dictionary definition may have a higher ranking of source than Wikipedia, Bloomberg is ranked higher than CNBC, etc.). Whether a response is shown to the user may also relate to an error rate setting within the bot, and therefore the rejection rate may be adjusted. For instance, there may be a number of adjustable error rate settings, such as recognition error rates (e.g., in the audio input), error rates relating to the triggering events (e.g., judgement), error rates in determining optimal sources of data, error in matching a particular NTL to a data response, and error in determining relevancy or ranking of search results. Notably, the bot may be adjustable to retrieve more or less information.

Further, historical information and/or feedback regarding a particular subscriber may be used to determine whether information is worthy of being provided to the subscriber (e.g., the subscriber is an expert in a particular field—he/she does not need to see Wikipedia definitions). Also, the response may be graded according to its relevance to the NLT and/or determined context. If the signal is deemed adequate in act 212, the bot sends a message to the subscriber including the information retrieved from the data source at 214. Optionally, messages sent to the subscriber are logged in a storage entity. Otherwise, process 200 ends and a message is not sent to the subscriber.

Additionally (or alternatively), one or more actions may be taken in act 214 based on the information retrieved from the data source. For example, the system may execute a stock trade in response to information indicating that the price of a particular equity is below a threshold value (e.g., below $5, $10, $15, $20, $25, etc.). It should be appreciated that any of a variety of actions may be performed based on the information from retrieved from the data source such as: ordering a taxi, ordering food, turning on/controlling one or more electronic devices, and/or sending an electronic communication (e.g., an email).

The process described above are illustrative embodiments and are not intended to limit the scope of the present disclosure. The acts in the processes described above may be ordered in any suitable way. Accordingly, embodiments may be constructed in which acts are performed in an order different than illustrated, which may include performing some acts simultaneously, even though shown as sequential acts in illustrative embodiments.

### Example Multi-Channel Communication System and Associated Methods

The architecture described above to proactively generate relevant information without input from a user may be employed in any of a variety of ways. The inventors have appreciated that such technology may be employed to augment conversations with relevant information. For example, a question may come up in conversation (e.g., when is the next Christmas?) that may be answered through a response generated by the architecture. Accordingly, aspects of the present disclosure relate to the integration of a secondary communication channel with a primary communication channel to augment the communication over the primary communication. For example, a first individual may be talking to a second individual using a first communication channel (e.g., using the telephone). In this example, information relevant to the conversation may be presented to the first individual (and/or the second individual) using a second communication channel (e.g., a display of a computing device or a pair of augmented reality glasses). Thereby, the conversation over the primary channel is augmented with additional information from the secondary channel. In one implementation for illustration, a first individual may be talking to the second individual about the company GENERAL MOTORS. In this implementation, the phrase GENERAL MOTORS would be recognized and information about GENERAL MOTORS (e.g., current product offerings, current stock price, current executive officers) would be presented to the first and/or second individual to augment the conversation.

In some embodiments, the secondary communication channel available to only some of the parties participating in the conversation (e.g., the subscribers). For example, a first and second individual may be participating in a conversation and only the first individual may be a subscriber. In this example, only the first individual would receive information from the secondary communication channel. It should be appreciated that subscribers need not be human users. A computer program may be a subscriber to the secondary communication channel and receive information from the secondary communication channel. For example, a computer program may subscribe to a secondary communication channel and analyze the messages transmitted over the secondary communication channel to identify additional relevant information to be injected into the secondary communication channel.

The introduction of a secondary communication channel provides numerous advantages to subscribers. For example, the messages provided over the secondary communication channel may be provided in real time, with low latency. The messages may include, for example, information (e.g., biographical sketches, DUNS information, treatment options, or stock prices) regarding named entities (e.g., people, organizations, diseases, or stocks, respectively) mentioned in the primary communication channel. Such information may potentially advantage the subscribers over the other parties or, if all parties are subscribers, can serve as a general enhancement to the primary communication.

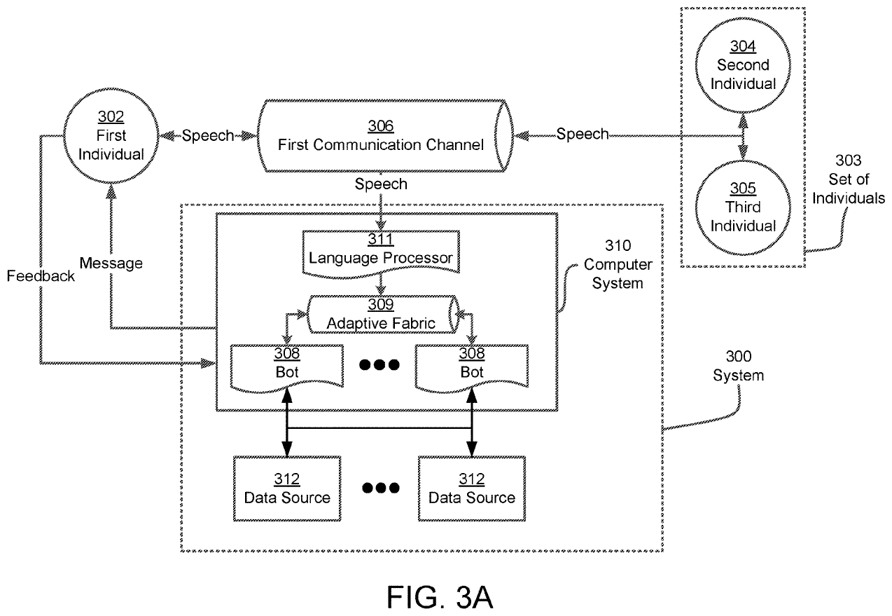

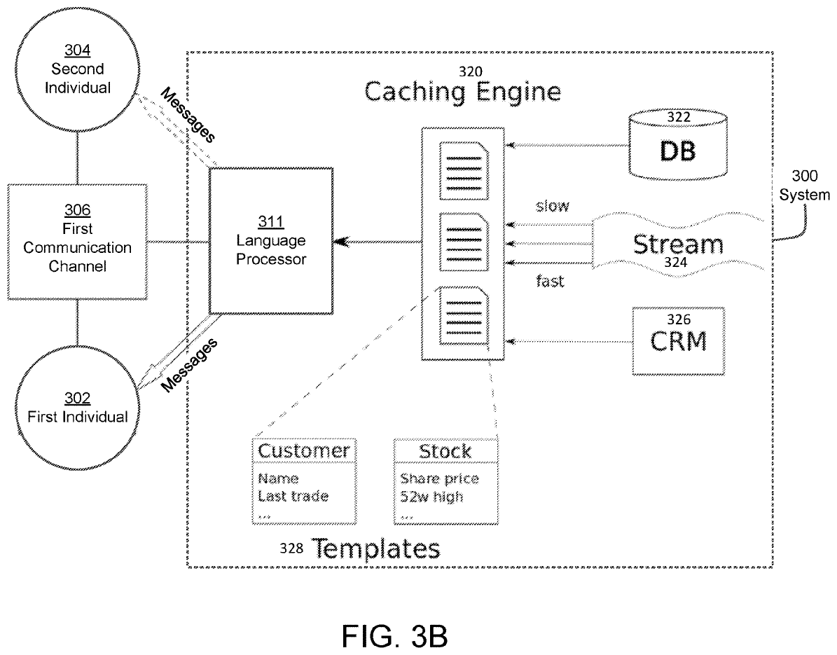

FIG. 3A shows an example system 300 configured to provide a secondary communication channel to a first individual 302 who is a subscriber to the system 300. As shown, the first individual 302 is verbally communicating with a set of one or more individuals 303 (shown as including a second individual 304 and a third individual 305) over a first communication channel 306. The system 300 receives the speech and processes the speech to provide a message to the first individual 302 that is relevant to one or more topics in the speech. The system 300 includes a computer system 310 that executes a language processor 311 to process the detected speech, an adaptive fabric component 309 to route information between various components within the computer system 310, and bot computer programs 308 that search data sources 312 to obtain relevant information to include in the message to the first individual 302. The system 300 also receives feedback that may be employed to improve subsequent messages generated by the system 300.

It should be appreciated that the example system 300 shown in FIG. 3A is only for illustration. Various changes may be made to the system 300 without departing from the scope of the present disclosure. For example, the computer system 310 may execute more (or less) bots 308 and/or use hardware acceleration (e.g., by GPUs, FPGAs, and cloud implementations of GPUs or FPGAs) to minimize latency of the system 300. Additionally (or alternatively), the system 300 may comprise a pair of augmented reality glasses (e.g., GOOGLE GLASS) to display messages to the first individual 302 and/or receive feedback from the first individual 302. The computer system 310 may be integrated with the pair of augmented reality glasses and/or communicatively coupled to the pair of augmented reality glasses (e.g., via a wireless communication network). For example, the computer system 310 may be implemented as a mobile electronic device (e.g., a smartphone) that is communicatively coupled to the pair of augmented reality glasses using a BLUETOOTH connection.

The first communication channel 306 may be a channel suitable for verbal (and/or visual) communication between two or more individuals (e.g., 2, 3, 4, 5, etc. individuals). In some embodiments, the individuals (e.g., first and second individuals 302 and 304, respectively) communicating over the first communication channel 306 may not be at the same location and/or point in time. For example, the first individual 302 may be in Houston, Texas communicating with the second individual 304 in Los Angeles, Calif. In another example, the first individual 302 may be listening to the set of one or more individuals 303 on a television show was previously taped two months ago. In these embodiments, the first communication channel 306 may include various devices to facilitate communication between the first individual 302 and the set of individuals 303. For example, the first communication channel may include one or more: telephony devices (e.g., a mobile phone and/or a landline phone), telepresence devices (e.g., a telepresence robot), extended reality (XR) devices (e.g., virtual reality (VR) devices, augmented reality (AR) devices, and mixed reality (MR) devices), radio broadcast devices (e.g., a microphone and/or a speaker), video conferencing devices (e.g., a camera and/or a display), and/or television (TV) devices (e.g., a display).

It should be appreciated that the individuals (e.g., the first and second individuals 302 and 304) communicating over the first communication channel 306 may be in the same place at the same time. For example, the first individual 302 may be in the same coffee shop as the set of one or more individuals 303. Accordingly, in some embodiments, the first communication channel 306 may not include any devices at all. In these embodiments, the first communication channel 306 may include the space through which a voice of an individual is propagating. For example, the first individual and the set of one or more individuals 303 may be talking in the same room and the first communication channel 306 may include the open space between the individuals participating in the conversation.

The system 300 may be configured to receive speech in any of variety of ways. For example, the first individual 302 and the set of one or more individuals 303 may be talking in a room and the system 300 may employ a microphone to directly detect the speech. This microphone may be, for example, implemented within augmented reality or mixed reality glasses, smartphone, or other computer device where information is output or projected onto a same or different device. In another example, the first individual 302 and the set of one or more individuals 303 may be verbally communicating over a video conference and the system 300 may receive the speech from an application hosting the video conference (e.g., SKYPE by MICROSOFT). In yet another example, the first individual 302 and the set of one or more individuals 303 may be verbally communicating over a teleconference hosted by a VoIP system and the system 300 may receive the speech from one or more websockets in communication with the VoIP system. In one example embodiment, the microphone is implemented within augmented reality or mixed reality glasses (e.g., GOOGLE GLASS by GOOGLE) and permits one or more persons in the conversation who wear the glasses to view output of information projected on the glasses. In another example implementation, the microphone is implemented on a smartphone and the output occurs on augmented reality or mixed reality glasses. In another specific implementation, the system 300 may use a specialized version of augmented or mixed reality glasses specifically for purposes related to aspects of embodiments that do not require computer vision, enabling the cost of the device to be lower, and providing capabilities for enriching voice conversations.

Once the system 300 has received the speech, the system 300 may be configured to process the speech and gather information from the data source 312 that is relevant to the speech and provide the relevant information in a message to the first individual 302. In some embodiments, the speech may be processed by a language processor 311 installed on a computer system 310 in the system 300. In these embodiments, the language processor 311 may convert the speech to text and/or identify key words or phrases using any of a variety of NLP and/or automated speech recognition (ASR) techniques. The processed speech output by the language processor 311 may be provided as input to one or more bot computer programs 308 via the adaptive fabric 309. The adaptive fabric 309 may control which bots 308 in the system 300 receive selected portions of the processed speech using a set of rules. For example, the adaptive fabric 309 may send processed speech from the first individual 302 to a first bot and second processed speech from the second individual 304 to a second bot. Once the bots 308 have received the processed speech, the bots may be configured to use words and/or phrases from the processed speech to perform a search of the data sources 312 for relevant information. For example, the processed speech may include a reference to a specific entity (e.g., the company GM) and the bot 308 may read the data source 312 to find information related to the specific entity (e.g., a current stock price of GM) and provide the information in a message to the first individual 302. The bot 308 may provide the message to the first individual 302 using, for example, any of a variety of output devices of the computer system 310. For example, the computer systems 310 may be implemented as a pair of computer-enabled glasses (e.g., GOOGLE GLASS by GOOGLE) and display the message on a transparent plate proximate an eye of the first individual 302.

It should be appreciated that the system 300 may, in some embodiments, never store the speech data in a non-volatile memory to protect to the privacy of the individuals in the conversation. A non-volatile memory may be any computer memory that retains the data stored therein while powered off (e.g., a disk drive, a ready only memory (ROM), an optical disk, etc.) while volatile memory may be any computer memory that uses power to maintain the information stored therein (e.g., random access memory (RAM), a processor cache, etc.). Instead of storing the speech data in volatile memory, the system 300 may only temporarily store the speech data in volatile memory for processing. Similarly, any text generated from the speech data (e.g., text generated by a speech-to-text conversion) may also only be temporarily stored in volatile memory for processing. The processed speech data (and/or text data) may be deleted from the volatile memory once the data is no longer needed. Thereby, the speech data (and/or any text data) is prevented from being stored for any extended period of time and from being stored in non-volatile memory.

In some embodiments, the system 300 may be adapted over time to provide better information to the first individual 302. In these embodiments, the system 300 may receive feedback from the first individual 302 regarding the previously provided message and use this received information to provide better information. The feedback may take any of a variety of forms. For example, the system 300 may directly receive feedback from the individual regarding a message in the form of up-votes/likes (indicating the information was helpful) and/or down-votes/dislikes (indicating the information not helpful). Alternatively (or additionally), the system may receive feedback indirectly from the user by tracking the actions of the user after providing the information. For example, the bot 308 may receive a speech segment including a reference to the company “GM,” provide a message indicative of a stock price of GENERAL MILLS, and determine that the first individual 302 did not engage in any behavior related to GENERAL MILLS (e.g., discuss products made by GENERAL MILLS, purchase stock of GENERAL MILLS, or sell stock of GENERAL MILLS). In this example, the bot 308 may determine that the message was unhelpful and be adapted to provide information regarding a different company, such as GENERAL MOTORS, when the speech segment “GM” is received again. In another example, the bot 308 may have received a speech segment about visiting an individual, provide an address associated with the individual, and detect that the first individual 302 used the provided address to call a taxi. In this example, the bot 308 may determine that the contact information was helpful.

It should be appreciated that the system 300 may, in some embodiments, receive feedback from individuals other than a subscriber (e.g., individual 302). In these embodiments, the system 300 may receive information from individuals that are associated with the subscriber (e.g., a family member, a work college, another member of a club, etc.). For example, the system 300 may receive information indicative of how many individuals within a social circle of the subscriber read and/or shared a particular article. In this example, the system 300 may be configured to preferentially provide articles that have been well received by individuals in the social circle of the subscriber over articles that have not been viewed by individuals in the social circle of the subscriber.

In some embodiments, the bot 308 may be a real-time program that responds to verbal triggers within normal speech to search and retrieve information from data sources. Certain bots may be particularly suited for certain data sources, and a number of bots can be programmed to monitor a single audio source and/or conversation. Certain bots may be assigned to certain users and may be adapted to perform tasks specific to the assigned user. It should be appreciated that the bot 308 may be implemented as a computer program that is a stand-alone computer program or integrated into another computer program. For example, the bot 308 may be integrated into a voice and/or video chat application (e.g., SKYPE). In this example, the bot 308 may directly access the voice information being passed between two or more users of the application and provide information to a subscriber through the voice and/or video chat application.

In another embodiment, a bot may be configured to respond to individuals within a conversation. For instance, a bot may be programmed to passively understand conversational or indirect commands from a received voice signal, where a request is spoken to another person versus directly to a bot. In one implementation, the bot is programmed to monitor the voice signal for indirect commands spoken during conversation and then what is replied to the indirect command by other participants, and accordingly return relevant data to the subscriber. Examples of this may include a situation where Person A says to Person B “Can you spell that”, “Spell their name for me”, “What's the URL”, “What is their email address”, “What's your account number”, “What's your home address,” etc. In each of these cases, Person A has indirectly issued a command to a bot via Person B. Person B thinks they are providing information to Person A, but according to one implementation, the command is actually processed by the bot to assist Person A (who in this case is the subscriber) in some manner. In another implementation, a bot associated with Person A may receive the information from a bot associated (and controlled) by Person B. Person B may issue speech that authorizes information from Person B to be transferred to Person A (e.g., via the bot for Person A). Further, aspects of a system may support pre-existing indirect commands as well as programmable indirect commands that users and/or companies can define.

Feedback received from the first individual 302 may take any of a variety of forms. For example, the bot 308 may display a message to the first individual 302 using a screen of the computer system 310 and include a control element that allows the first individual 302 to indicate that the message is irrelevant to the conversation. In another example, the bot 308 may provide a message and look for references to the message in later speech. If the bot 308 detects speech related to (or including) information in the message, the bot 308 may determine that the information was useful. In contrast, if the bot 308 does not detect speech related to (or including) information in the message, the bot 308 may determine that the information was irrelevant.

In some embodiments, the bot 308 may be configured to predict one or more events based on previous conversations. In these embodiments, the bot 308 may analyze previous conversations between two or more individuals to identify patterns. Thereby, the bot 308 may be able to identify one of the identified patterns being repeated and pre-emptively provide messages to the subscriber based on the identified pattern being repeated. For example, an individual may always ask “what is the price of FORD stock?” after talking about one or more vehicles manufactured by FORD (e.g., FIESTA, FOCUS, ESCAPE, EDGE, EXPLORER, etc.). In this example, the bot 308 may recognize this pattern and automatically provide a message to a subscriber including the stock price for FORD when one or more FORD vehicles are discussed irrespective of whether the question “what is the price of FORD stock?” has been asked. Thereby, any subscribers participating in the conversation will already have an answer to a question that likely will be asked. Such event prediction may be employed in any of a variety of applications such as preventative compliance.

It should be appreciated that two or more systems 300 that are augmenting different conversations may be networked together to provide additional functionality. In some embodiments, one or more of the individuals (e.g., the first individual 302) participating in the conversations may be identified as a subject matter expert. In these embodiments, the responses to questions within the area of expertise of the subject matter expert may be stored as answers to those questions that may be provided to other individuals. For example, the first individual 302 may be an expert on the petroleum industry and be asked the question “why is the price of oil rising?” by another individual (e.g., the second individual 304). In this example, the bot 308 may record the answer provided by the first individual 302, store the answer with the question “why is the price of oil rising?” and provide the stored question and answer pair to other systems 300 within the network. Thereby, other systems 300 within the network can provide the answer stated by the petroleum industry expert as a message to subscribers in response to detecting the question “why is the price of oil rising?” The subject matter experts may be identified in the system 300 through an interface (e.g., a graphical user interface) of the computer system 310. For example, an administrator may access the interface to specify which individuals are subject matter experts in which areas. Additionally (or alternatively), voice recordings of the identified individuals may be provided to the computer system 310 to enable the system 300 to train one or more models to differentiate the voice of the identified individuals relative to other individuals.

In some embodiments, the information gathered and/or generated by one or more bots 308 in a network of systems 300 may be stored and/or employed for subsequent analysis. For example, the NLTs in the speech input into the bots 308 may be paired with the messages generated by the bots 308 and stored (e.g., in a table) as a summary of events. The summary of events may be communicated (e.g., emailed) to a specified list of one or more individuals for review. Additionally (or alternatively), the summary of events (or any other stored information) may be employed to train one or more bots 308 (e.g., to reduce error rates and/or provide responses to a wider range of NLTs). The stored information (e.g., the summary of events) may be text searchable to enable the stored information to be easily searched.

FIG. 3B shows another implementation of the system 300 that employs a caching engine 320 to, for example, reduce the latency between detecting an NLT and providing a message to a subscriber. The caching engine 320 may, for example, store select information (e.g., according to a template—shown as templates 328) from data sources (shown as a database (db) 322, a data stream 324, and a computer readable medium (CRM) 326) that may be frequently employed to generate messages. Thereby, the caching engine 320 may be able to provide relevant information faster than the alternate method of identifying and/or searching an external data source for the information. The caching engine 320 may be, for example, integrated into a bot (e.g., bot 308 shown in FIG. 3A) and/or implemented as a separate component that may be executed by a processor of the system 300.

The caching engine 320 may comprise (and/or have access to) a cache storing a hash table that is keyed on the keyword (kw) field. For each key, the cache may contain a structure with three further fields: an integer (or bit field) segment number (sn), a float logprob (lp), and a (function) pointer data trigger (dt). Since a single record is likely less than 24 bytes, and current ASR keyword search systems are unlikely to deal with more than 50,000 keywords/key phrases, the entire cache is easily fit in 2MB of memory (e.g., volatile memory).

The kw field is identical between the ASR and the cache, but not necessarily between the cache and the data sources. For example the data may refer to IBM, but the relevant (from the standpoint of ASR) keyword may be eye-bee-em. Most modern ASR systems will have software support for text-to-phoneme conversion from textual to phonemic representation.

The sn field identifies the data source(s) that the eventual material is coming from. For example, Ford may refer to the shares of the Ford Motor Corporation, for which data will come from Bloomberg, or to Henry Ford, for which data would come from Wikipedia. (Initially, no deeper disambiguation is attempted, so Clinton is defaulted to Hillary rather than Bill Clinton or the town of Clinton, Ohio. Later, a variety of NLP techniques may be employed to resolve such ambiguities)

The lp field refers to our estimate of the probability of a particular keyword appearing in the conversation, e.g. that Facebook is more likely than Tata Steel. These estimates may be updated in any of a variety of ways such as employing Bayesian updates based on the contents of the conversations and/or user-supplied keyword lists. Note that lp is distinct from the confidence value returned by the ASR system, and the update will involve both.

Finally, the dt field refers to both immediate function calls for those segments where the data source is low latency (e.g. Bloomberg) and to precomputed html pages for those segments where the data source is high latency, e.g. Outlook. This is the same distinction as in CPU caches between instruction and data cache, except here it is keyed on segment number not on hardware location.

The cache may be rebuilt every night or, if such operation makes sense, several times a day. Most parts, such as the keyword list, change adiabatically, perhaps 1% day to day, and the change is easily absorbed on the ASR side (by a simple restart). Other parts, such as Outlook/Exchange or Salesforce may change on a faster scale. It should be appreciated that a multi-layer cache (e.g., a two, three, four, five, etc. layer cache) may be employed. In some embodiments, there may be only two layers: the innermost (L0) cache discussed above, which at 2 MB is small enough to keep in memory on all instances at all time, and the munged data (L1) cache is likely to be in the 20-50 GB range.

In some architectures, each integration will correspond to a separate bit in the sn bit field, and each will have its own dedicated (non-reusable) feeders and mungers. A feeder may be a function, specific to the API or SDK used in that integration, that takes a keyword such as “DELTA” and a context such as current price on, to produce a query such as =BDP(“delta us equity”,“px last”) which gives a Bloomberg Data Point (BDP) on the last trade of DELTA. The munger may be another function that converts the returned value to a user-friendly format.

What constitutes an answerable question depends entirely on the segment that the info source belongs in: Bloomberg will have information on current trades, and Wikipedia will not. However, if decided in advance that the system 300 needs to be responsive to queries answered by Wikipedia without having Wikipedia serve the answer at runtime: rather, the querying may be completed overnight and collect the responses in Amazon S3 objects (or the equivalent under other object storage schemes) which are periodically refreshed in the background by the feeders and mungers. For Wikipedia, the answer is already in HTML, so the mungers play only a minimal role, but in many cases the response format needs to be converted to HTML from other formats.

In view of the foregoing description of a system to provide a secondary communication channel to one or more subscribers, it should be appreciated that such systems may be employed to augment conversations in any of a variety of circumstances. In some embodiments, the system may be employed to facilitate training of customer-facing employees at a company (e.g., sales people and/or customer service representatives). For example, the system may receive (via a graphical user interface (GUI)) a set of questions and desired answers from a customer service manager. The system may listen to conversations between trainee customer service representatives and customers to identify questions asked by the customer that are similar (or the same) as the predefined questions. In this example, the system may, in response to detecting a match between a question asked by the customer and a predefined question, provide the trainee customer service representative the desired answer to the question. In another example, the system may receive audio of expert sales people interacting with customers as training data and use various techniques (e.g., machine learning techniques) to identify various patterns in the training data. In this example, the system may listen to the conversations of trainee sales people and make real-time suggestions to the trainee sales people based on the patterns identified in the received training data. In another example, the system may be trained (e.g., using a machine learning technique) with detailed information regarding the products and/or services offered by a company. In this example, the system may listen to calls between sales people and customers and provide answers to specific questions asked by the potential customer (e.g., what was the server uptime last month?).

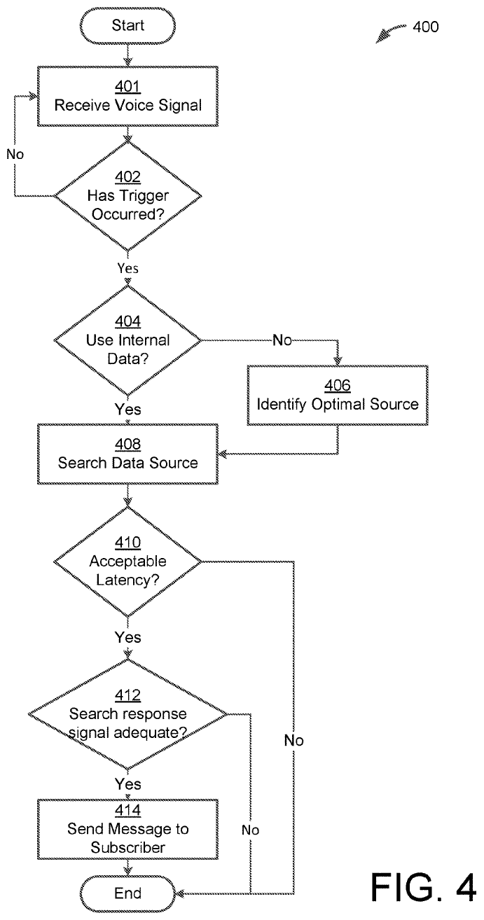

As discussed above, the system 300 may be configured to receive voice signals indicative of speech between two or more individuals and provide messages to a subscriber (e.g., the first individual 302) to augment the detected speech. FIG. 4 shows an example process 400 for generating such messages for the subscriber. As shown, the process 400 includes an act 401 of receiving a voice signal, an act 402 of determining whether a trigger has occurred, an act 404 of determining whether to use internal data, an act 406 of identifying an optimal source, an act 408 of searching the data source, an act 410 of determining whether the latency is acceptable, an act 412 of determining whether the search response signal was adequate, and an act 414 of sending a message to the subscriber.

In act 401, the system receives voice signals indicative of speech between two or more individuals (e.g., 2, 3, 4, 5, etc. individuals). The system may detect the voice signals by, for example, microphone communicatively coupled to the system.

In act 402, the system determines whether a trigger event has occurred for the received voice signal. For instance, the system may monitor a particular audio stream and determine whether an event occurs within the natural language. The triggering event may be, for example, a predefined wake-up word and/or a natural language trigger (NLT). An NLT may be a word or phrase used in normal conversation that triggers a bot to perform an action. The particular NLT used by a bot may vary based on the type of information that the bot is configured to provide. For example, a bot configured to provide stock information may have NLTs including the names and/or ticker symbols of each company that is publicly traded on the New York Stock Exchange (NYSE).

In act 404, the system may determine whether data internal to the system architecture may be used to accurately augment the voice signal received in act 402. For example, the system may determine it can deliver the necessary data or “an accurate answer” (on a probabilistic basis) using internal data better than using third party sources because it is faster than checking other sources (lower latency), more accurate than other sources, and/or in some cases may be the only system that can provide the data the subscriber is seeking. In some embodiments, the system may have direct access to some database, a computational program, or an analytics program which enables it to provide the data or to calculate an answer. In addition, the system may utilize machine learning, reasoning, neuroscience, and cognitive artificial intelligence techniques that learn answers over time, and stores this information such that it can provide internal data or answer more quickly versus spending time looking on a third party data source.

If the system determines that the best data must be obtained from a third party data source in act 404, the system proceeds to act 406 and determines the optimal data source. The system may apply semantic context on the content to see if it can be determined which is the optimal data source. For example, reference to the term “file” may indicate the best match would be best found in a document repository (e.g., DROPBOX). In addition, the system may continuously self-learn to determine which data source is the optimal data source by using machine learning techniques (where initial embodiment of the invention shall use neural networks, but new techniques may be considered including memory networks, cognitive science/reasoning techniques) in order to reduce the latency to deliver a message to the subscriber.

It should be appreciated that other approaches may be employed additionally or in-place of semantic context. Other example approaches include, but not limited to, storing NLTs and associated best data sources in: (i) a connected (either inline or otherwise) caching engine in real-time (as used in high frequency trading systems); (ii) in a dynamic topics/source table (similar to a routing table in a publish/subscribe system) which the system continuously updates in real-time where when an NLT) is generated, the routing engine checks to see if it matches a previously stored NLT and data source; or (iii) within memory networks. The system may also use anomaly detection to expedite learning to identify outliers for NLTs and determining if there is new information to be learned, and how to utilize that information with regards to NLTs and data sources.

If there is a single previous mapping of an NLT to a data source using these techniques described above, the system may immediately access this data source, match the data by NLT, and deliver data to the subscriber. If there are multiple mappings or matches to an NLT across sources, an algorithm may be applied to define what data is shown to the subscriber to, for example, eliminate overwhelming the subscriber with too much data. The algorithm may be a function of time (e.g., reducing latency to milliseconds), best data source, and context of the content. This use of context may employ machine learning and cognitive techniques, and information regarding context may be stored and retrieved by the system. After a certain amount of time/latency, if data is found from one source and no other data is found, data from the only available source may be delivered to the subscriber. In other words, given the real-time nature requirements of the system there needs to be some cut-off as to how long the system can seek data from other data sources. In certain cases even the best available data won't be shown to a specific subscriber depending on any new trigger events that may arise from the initial trigger event for a specific subscriber. Alternatively (or additionally) the system may make a determination on its own if there is signal and if the system can deliver relevant data in a timely manner that is useful to the subscriber. If not, the system may discard the data for a specific signal/NLT and seek to deliver on the next event trigger. In this manner, the system may function like a daemon in a market data architecture where it passes on some data to the subscriber and discards other data based on some pre-defined rules. Those rules may be based on latency, data relevancy, and learning of the system itself based on machine techniques. In some implementations, the user or other interface (e.g., an adjustable slider, menu item, or other control input) may be provided that allows an external entity to control the parameters of the system (e.g., a bot), such as acceptable latency, error rates in reporting, triggering, weighting of certain data sources or other operational parameters. It should be also noted that in certain implementations, data from multiple sources may be shown either as a function of configuration by subscriber or as determined by the system itself.

If there is no clear existing mapping of an NLT, the system may actively seek matches using application program interfaces (APIs) of data sources. In certain embodiments, the system may use existing Natural Language Processing (NLP) products that already analyze and classify data from a source or even a market sector (examples of these NLP products include, for example, FINDO). These may serve as new NLP liquidity pools that parallel market data liquidity pools similar to ones created by ARCHIPELAGO for market data. The system may connect and integrate with these NLP liquidity pools systems in terms of integrations and also in terms of having knowledge which is the best source for a specific NLT. The system may leverage context-based NLT-to-NLT connectors for data requests to NLP liquidity to optimize for low latency and functionality. For example, this will allow for complex and contextual natural language queries as opposed to just keyword searches. The system may utilize machine learning techniques to learn and remember what contextual NLT queries produced the best results from each source.

In cases where there are no NLP products, integrations, or liquidity pools, the system may seek to provide its own real-time integrations for data sources and market sectors. In addition, the system may provide a Developer's API and platform for third parties to integrate their own applications as data sources into the architecture, which would allow their data to be accessible by our middleware and therefore any relevant subscribing node (user or application). This may provide a mechanism for the system to have access to and index data from other applications.

Once the best data source has been identified, the system may proceed to act 408 to search the identified data source to obtain information that is related to and/or augments the information received in act 402.

In act 410, the system may determine whether the resulting latency between the time the information was received in act 402 and the time the message would be sent to subscriber (if it were to be sent) is acceptable. For example, the system may identify how much time has passed since the information was received in act 402 and determine whether the identified amount of time exceeds a threshold (e.g., 2, 3, 4, 5 seconds or any other threshold amount within a defined tolerance for the application and/or usability of the system in real time). In one embodiment, information should be capable of being delivered with minimal delay from triggers detected within a running conversation or other type of input. According to one embodiment, the information should be capable of being delivered within a threshold period from determination of the NLT. If the latency is acceptable, the system proceeds to act 412 to determine whether the search result has a signal that is worthy of being reported to the user. For instance, in one embodiment, the determination of whether a response is worthy to be returned to a user may be based on a number of factors. For instance, a ranking score may be used to evaluate multiple responses (e.g., received from one or more data sources), and return a few or even one highest ranked response to the subscriber. For instance, the ranking may depend, at least in part, on a ranking of the source of the information (e.g., a dictionary definition may have a higher ranking of source than Wikipedia, Bloomberg is ranked higher than CNBC, etc.). Whether a response is shown to the user may also relate to an error rate setting within the bot, and therefore the rejection rate may be adjusted. For instance, there may be a number of adjustable error rate settings, such as recognition error rates (e.g., in the audio input), error rates relating to the triggering events (e.g., judgement) , error rates in determining optimal sources of data, error in matching a particular NTL to a data response, and error in determining relevancy or ranking of search results. Notably, the bot may be adjustable to retrieve more or less information.

Further, historical information and/or feedback regarding a particular subscriber may be used to determine whether information is worthy of being provided to the subscriber (e.g., the subscriber is an expert in a particular field—he/she does not need to see Wikipedia definitions). Also, the response may be graded according to its relevance to the NLT and/or determined context. If the signal is deemed adequate in act 412, the bot sends a message to the subscriber including the information retrieved from the data source at 414. Optionally, messages sent to the subscriber are logged in a storage entity. Otherwise, process 400 ends and a message is not sent to the subscriber.

Additionally (or alternatively), one or more actions may be taken in act 414 based on the information retrieved from the data source. For example, the system may execute a stock trade in response to information indicating that the price of a particular equity is below a threshold value (e.g., below $5, $10, $15, $20, $25, etc.). It should be appreciated that any of a variety of actions may be performed based on the information from retrieved from the data source such as: ordering a taxi, ordering food, turning on/controlling one or more electronic devices, and/or sending an electronic communication (e.g., an email).

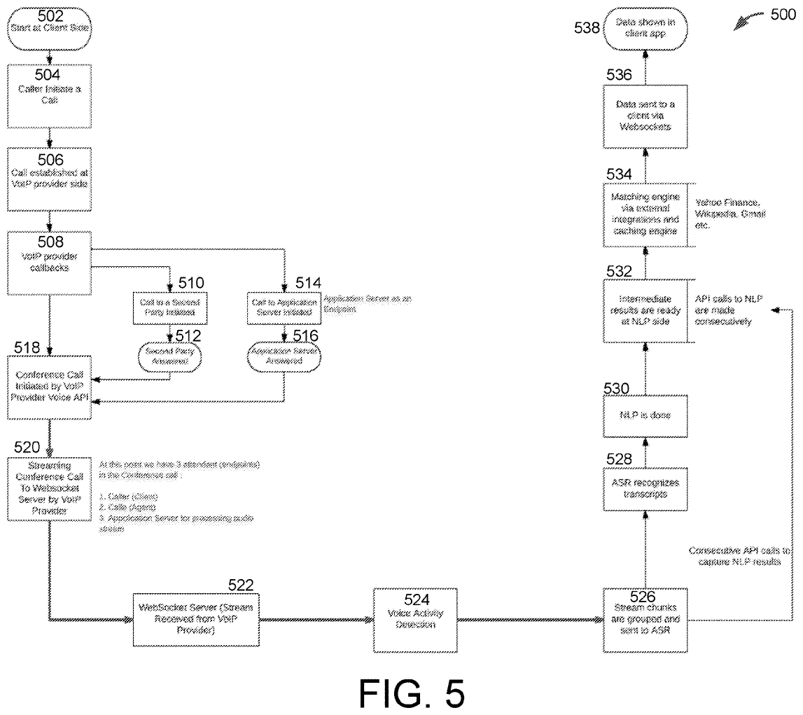

As discussed above with reference to FIGS. 3A and 3B, the primary communication channel may be a teleconference taking place over the internet (e.g., using voice-over-internet-protocol (VoIP)) and the secondary communication channel is a display screen on a computing device executing a software application in some embodiments. In these embodiments, any of a variety of techniques may be employed to access the voice data in the VoIP call to provide to the system 300 such that the system 300 can generate messages for the subscribers. In some implementations, websockets may be employed to provide access to the voice data in the VoIP call that may be subsequently processed to generate messages for subscribers. An example process to generate the messages to provide to the subscribers based on the voice data collected using the websockets is shown in FIG. 5 by process 500. It should be appreciated that other techniques may be employed to obtain access to the voice data in the VoIP call (e.g., using one or more APIs) and, thereby, one or more acts may be added, removed, or otherwise altered in 500 for different implementations.

As shown, process 500 starts on the client side in act 502 where a caller initiates a call to another individual (or group of individuals) using a VoIP telephone in act 504. Once the call has been initiated, the call is established at the VoIP provider side in act 506 and VoIP provider callbacks are made in act 508. Then, a call to a second party is initiated in act 510 causing the second party to answer in act 512. Similarly, a call to the application server is initiated in act 514 causing the application server to answer the call in act 516. Once the calls have been answered, a conference call is initiated by the VoIP Provider Voice API in act 518. Thereby, the conference call has three participants: (1) the original caller; (2) the second party called by the original caller; and (3) the Application Server that is configured to process the audio stream. The conference call may be streamed to a websocket server by the VoIP provider in act 520. Accordingly, the websocket server may receive the audio stream from the VoIP provider in act 522 and detect voice activity in act 524.

Once voice activity has been detected, the audio stream chunks may be grouped and sent to ASR instances in act 526. Thereby, the ASR recognizes the transcripts in act 528 (e.g., converts the speech to text) causing the NLP to be done in act 530 and the intermediate results to be ready at the NLP side in act 532. Additionally, one or more consecutive API calls may be made to the NLP to capture the NLP results (shown as the line between act 526 and 532). The results of the NLP may be provided to a matching engine via external integrations and/or a caching engine to, for example, access external data sources (e.g., Yahoo Finance, Wikipedia, Gmail, etc.) to generated relevant messages for the client in act 534. The generated data (e.g., the messages) may be sent to the client via websockets in act 536 where the generated data is shown in a client application in act 538.

The processes described above are illustrative embodiments and are not intended to limit the scope of the present disclosure. The acts in the processes described above may be ordered in any suitable way. Accordingly, embodiments may be constructed in which acts are performed in an order different than illustrated, which may include performing some acts simultaneously, even though shown as sequential acts in illustrative embodiments.

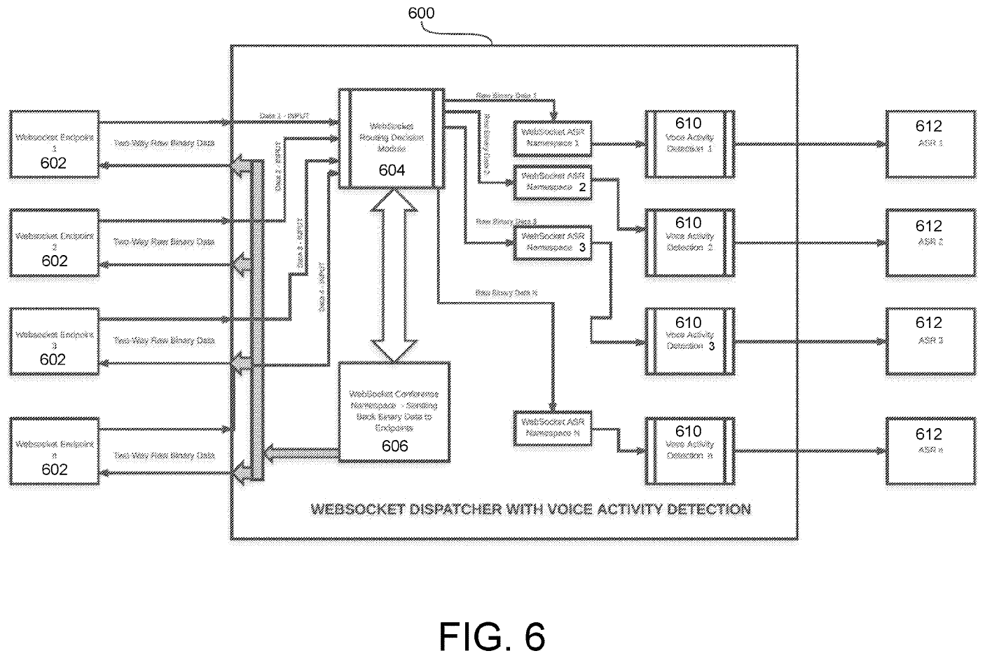

FIG. 6 shows an example websocket dispatcher 600 according to some embodiments that may be employed to provide system 300 access to speech in a VoIP teleconference between a plurality of individuals. It should be appreciated the websocket dispatcher 600 may be implemented in other ways than shown in FIG. 6. Further, other techniques (separate and apart from websockets) may be employed to provide a system (e.g., system 300) direct access to voice data in a VoIP teleconference (e.g., using APIs instead of websockets).

As shown, the websocket dispatcher 600 is communicatively coupled to a plurality of websocket endpoints 602 (shown as websocket endpoints 1-n). The websocket dispatcher 600 may receive voice information (e.g., speech data) from one or more individuals in a VoIP call from each of the websocket endpoints. For example, the websocket dispatcher 600 may receive voice information associated with a first individual in a first teleconference and the websocket dispatcher 600 may receive voice information associated with a second individual in the first teleconference or in a second, different teleconference. The websocket dispatcher 600 may route the incoming voice data to one or more ASR instances 612 (shown as ASR 1-n). Each of the ASR instances may be configured to, for example, convert the voice data to text.

The websocket dispatcher 600 may route the voice data from different websocket endpoints 602 to the ASR instances 612 in any of a variety of ways. As shown, the websocket dispatcher 600 may comprise a websocket routing decision model 604 that routes the incoming data to different ASR instances. Accordingly, the data output by the websocket routing decision module 604 may be assigned to different namespaces depending upon the ASR instance to which the data is to be provided to (shown as websocket ASR namespaces 1-N). The websocket routing decision module 604 may be communicatively coupled to a websocket conference namespace 606 that is configured to send data (e.g., binary data) from the websocket dispatcher 600 to the websocket endpoints 602.

The websocket dispatcher 600 may, in some embodiments, comprise voice activity detectors 610 that determine whether a data stream output by the websocket routing decision model 604 comprises voice activity (instead of silence or background noise). The voice activity detectors 610 may identifier portions of the data stream that contain voice activity and send the identified portions to an ASR instance 612. Thereby, the portions of the data stream that do not contain voice activity may be kept from the ASR instances 612.

### Example Special-Purpose Computer System

In some embodiments, a special-purpose computer system (e.g., computer systems 110 and/or 310) can be specially configured as disclosed herein (e.g., to provide messages to a subscriber in real-time (or near real-time) based on received information and/or to provide a secondary communication channel to one or more subscribers). The operations described herein can also be encoded as software executing on hardware that may define a processing component, define portions of a special purpose computer, reside on an individual special-purpose computer, and/or reside on multiple special-purpose computers.

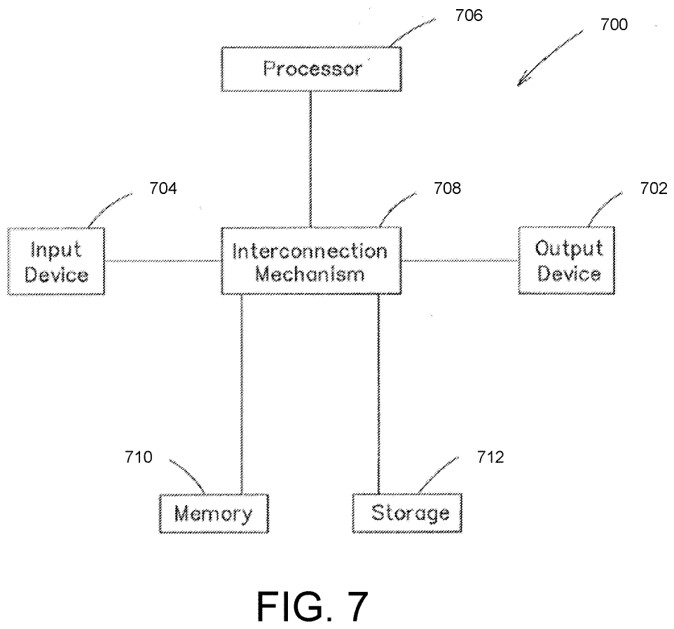

FIG. 7 shows a block diagram of an example special-purpose computer system 700 which may perform various processes including, for example, one or more acts of the processes 200, 400, and/or 500 described above. As shown in FIG. 7, the computer system 700 includes a processor 706 connected to a memory device 710 and a storage device 712. The processor 706 may manipulate data within the memory 710 and copy the data to storage 712 after processing is completed. The memory 710 may be used for storing programs and data during operation of the computer system 700. Storage 712 may include a computer readable and writeable nonvolatile recording medium in which computer executable instructions are stored that define a program to be executed by the processor 706. According to one embodiment, storage 712 comprises a non-transient storage medium (e.g., a non-transitory computer readable medium) on which computer executable instructions are retained.

Components of computer system 700 can be coupled by an interconnection mechanism 708, which may include one or more busses (e.g., between components that are integrated within a same machine) and/or a network (e.g., between components that reside on separate discrete machines). The interconnection mechanism enables communications (e.g., data, instructions) to be exchanged between system components of system 700. The computer system 700 may also include one or more input/output (I/O) devices 702 and 704, for example, a keyboard, mouse, trackball, microphone, touch screen, a printing device, display screen, speaker, etc. to facilitate communication with other systems and/or a user.

The computer system 700 may include specially-programmed, special-purpose hardware, for example, an application-specific integrated circuit (ASIC). Aspects of the present disclosure can be implemented in software, hardware or firmware, or any combination thereof. Although computer system 700 is shown by way of example, as one type of computer system upon which various aspects of the present disclosure can be practiced, it should be appreciated that aspects of the present disclosure are not limited to being implemented on the computer system as shown in FIG. 7. Various aspects of the present disclosure can be practiced on one or more computers having a different architectures or components than that shown in FIG. 7.

Various embodiments described above can be implemented using an object-oriented programming language, such as Java, C++, or C# (C-Sharp). Other programming languages may also be used. Alternatively, functional, scripting, and/or logical programming languages can be used. Various aspects of the present disclosure can be implemented in a non-programmed environment (e.g., documents created in HTML, XML or other format that, when viewed in a window of a browser program, render aspects of a graphical-user interface (GUI) or perform other functions). The system libraries of the programming languages are incorporated herein by reference. Various aspects of the present disclosure can be implemented as programmed or non-programmed elements, or any combination thereof.

It should be appreciated that various embodiments can be implemented by more than one computer system. For instance, the system can be a distributed system (e.g., client server, multi-tier system) that includes multiple special-purpose computer systems. These systems can be distributed among a communication system such as the Internet.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Further, some actions are described as taken by a “user.” It should be appreciated that a “user” need not be a single individual, and that in some embodiments, actions attributable to a “user” may be performed by a team of individuals.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The terms “approximately,” “substantially,” and “about” may be used to mean within ±20% of a target value in some embodiments, within ±10% of a target value in some embodiments, within ±5% of a target value in some embodiments, and yet within ±2% of a target value in some embodiments. The terms “approximately,” “substantially,” and “about” may include the target value.

Having thus described several aspects of at least one example, it is to be appreciated that various alterations, modifications, and improvements will readily occur to those skilled in the art. For instance, examples and embodiments disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A system, comprising:
at least one virtualized or hardware processor;
at least one non-transitory computer-readable storage medium storing processor-executable instructions organized as a first bot computer program that, when executed by the at least one virtualized or hardware processor, cause the at least one virtualized or hardware processor to perform acts of:
receiving information;
searching of at least one first data source using a first technique to find information to augment the received information;
determining an evaluation of the at least one first data source responsive to the received information;
determining a result from the search of the at least one first data source from the at least one first data source responsive to the evaluation of the at least one first data source; and
providing at least one first message comprising the determined result to at least one subscriber.

2. The system of claim 1, wherein the received information includes at least one of: a news article, speech by a subject, a discussion between two or more subjects, a video stream, an audio stream, a streaming dataflow, and a scientific study.

3. The system of claim 1 or any other preceding claim, further comprising receiving feedback from the at least one subscriber regarding the at least one first message and updating at least one characteristic of the first technique based on the received feedback from the at least one subscriber regarding the at least one first message.

4. The system of claim 1 or any other preceding claim, wherein the processor-executable instructions are organized as a plurality of bot computer programs, and wherein the plurality of bot computer programs each are adapted to process a same input of received information.

5. The system of claim 4 or any other preceding claim, wherein the same input of received information comprises a received audio stream.

6. The system of claim 1 or any other preceding claim, wherein the at least one first bot computer program includes a plurality of adjustable parameter comprising at least one of a resource parameter that defines a computer resource limit that can be used by the at least one first bot computer program.

7. The system of claim 1 or any other preceding claim, wherein the at least one first bot computer program includes a plurality of adjustable parameter comprising at least one of an error rejection parameter that defines a rate of error rejection used by the at least one first bot computer program.

8. The system of claim 1 or any other preceding claim, wherein the processor-executable instructions organized as the first bot computer program further cause the at least one virtualized or hardware processor to perform:
providing the at least one first message to the at least one subscriber responsive to generating the at least one first message within a predetermined period of time from receiving the information.

9. The system of claim 8 or any other preceding claim, wherein the predetermined period of time is no more than 2 seconds.

10. The system of claim 8 or any other preceding claim, wherein the predetermined period of time is no more than 4 seconds.

11. The system of claim 1 or any other preceding claim, wherein the first technique includes at least one artificial intelligence technique.

12. The system of claim 1 or any other preceding claim, wherein the at least one subscriber is non-human.

13. The system of claim 1 or any other preceding claim, wherein the at least one subscriber is a bot computer program.

14. The system of claim 1 or any other preceding claim, wherein the at least one non-transitory computer-readable storage medium further stores processor-executable instructions organized as a second bot computer program that, when executed by the at least one virtualized or hardware processor, cause the at least one virtualized or hardware processor to perform:
receiving the information;
searching at least one second data source using a second technique to find information to augment the received information; and
providing at least one second message to at least one subscriber based on a result from the search of the at least one second data source.

15. The system of claim 14 or any other preceding claim, wherein the processor-executable instructions organized as the second bot computer program further cause the at least one virtualized or hardware processor to perform:
receiving feedback from the at least one subscriber regarding the at least one second message; and
updating at least one characteristic of the second technique based on the received feedback from the at least one subscriber regarding the at least one second message.

16. A method, comprising:
receiving information;
searching of at least one first data source using a first technique to find information to augment the received information;
determining an evaluation of the at least one first data source responsive to the received information;
determining a result from the search of the at least one first data source from the at least one first data source responsive to the evaluation of the at least one first data source; and
providing at least one first message comprising the determined result to at least one subscriber.

17. At least one computer-readable storage medium storing computer-executable instructions that, when executed, perform a method comprising:
receiving information;
searching of at least one first data source using a first technique to find information to augment the received information;
determining an evaluation of the at least one first data source responsive to the received information;
determining a result from the search of the at least one first data source from the at least one first data source responsive to the evaluation of the at least one first data source; and
providing at least one first message comprising the determined result to at least one subscriber.

18. A system, comprising:
at least one virtualized or hardware processor;
at least one non-transitory computer-readable storage medium storing processor-executable instructions organized as a first bot computer program that, when executed by the at least one virtualized or hardware processor, cause the at least one virtualized or hardware processor to perform acts of:
receiving a voice signal indicative of speech;
identifying at least one first data source from a plurality of data sources;
searching the identified at least one first data source using a first technique to find information to augment at least a portion of the speech;
determining a result from the search of the at least one first data source; and
providing at least one first message comprising the determined result to at least one subscriber.

19. The system of claim 18, wherein the processor-executable instructions organized as the first bot computer program further cause the at least one virtualized or hardware processor to perform acts of:
receiving feedback from the at least one subscriber regarding the at least one first message; and
updating at least one characteristic of the first technique based on the received feedback from the at least one subscriber regarding the at least one first message.

20. The system of claim 18 or any other preceding claim, wherein the at least one non-transitory computer-readable storage medium further stores processor-executable instructions organized as a second bot computer program that, when executed by the at least one virtualized or hardware processor, cause the at least one virtualized or hardware processor to perform acts of:
receiving the voice signal indicative of speech;
searching at least one second data source from the plurality of data sources using a second technique to find information to augment at least a portion of the speech; and
providing at least one second message to at least one subscriber based on a result from the search of the at least one second data source.

21. The system of claim 20 or any other preceding claim, wherein the processor-executable instructions organized as the second bot computer program further cause the at least one virtualized or hardware processor to perform acts of:
receiving feedback from the at least one subscriber regarding the at least one second message; and
updating at least one characteristic of the second technique based on the received feedback from the at least one subscriber regarding the at least one second message.

22. The system of claim 18 or any other preceding claim, wherein the first technique includes at least one artificial intelligence technique.

23. The system of claim 18 or any other preceding claim, wherein the at least one subscriber is non-human.

24. The system of claim 23 or any other preceding claim, wherein the at least one subscriber is a bot computer program.

25. The system of claim 18 or any other preceding claim, further comprising a display and wherein providing the at least one message to the at least one subscriber includes displaying the at least one message on the display.

26. The system of claim 18 or any other preceding claim, wherein the processor-executable instructions organized as the first bot computer program further cause the at least one virtualized or hardware processor to perform an act of:
providing the at least one first message to the at least one subscriber responsive to generating the at least one first message within a predetermined period of time from receiving the voice signal.

27. The system of claim 26 or any other preceding claim, wherein the predetermined period of time is no more than 2 seconds.

28. The system of claim 26 or any other preceding claim, wherein the predetermined period of time is no more than 4 seconds.

29. The system of claim 18 or any other preceding claim, wherein at least one device that receives a voice signal indicative of speech includes at least one of a group of devices comprising augmented reality glasses, mixed reality glasses, virtual reality glasses, or a smartphone paired to any of the group of devices.

30. The system of claim 29 or any other preceding claim, wherein the at least one of a group of devices or the smartphone paired to any of the group of devices is adapted to project or output information to a screen.

31. The system of claim 30 or any other preceding claim, further comprising a specialized version of augmented or mixed reality glasses not having computer vision capabilities.

32. A method, comprising:
receiving a voice signal indicative of speech;
identifying at least one first data source from a plurality of data sources;
searching the identified at least one first data source using a first technique to find information to augment at least a portion of the speech;
determining a result from the search of the at least one first data source; and
providing at least one first message comprising the determined result to at least one subscriber.

33. At least one computer-readable storage medium storing computer-executable instructions that, when executed, perform a method comprising:
receiving a voice signal indicative of speech;
identifying at least one first data source from a plurality of data sources;
searching the identified at least one first data source using a first technique to find information to augment at least a portion of the speech;
determining a result from the search of the at least one first data source; and
providing at least one first message comprising the determined result to at least one subscriber.
